(19) United States
(12) Patent Application Publication
(10) Pub. No.: US 2018/0189743 A1
(43) Pub. Date: Jul. 5, 2018

(54) INTELLIGENT SCHEDULING MANAGEMENT

(71) Applicant: INTERNATIONAL BUSINESS MACHINES CORPORATION, Armonk, NY (US)

(72) Inventors: Swaminathan BALASUBRAMANIAN, Troy, MI (US); Sibasis DAS, Kolkata (IN); Richard GORZELA, Andover, MA (US); Peeyush JAISWAL, Boca Raton, FL (US); Priyansh JAISWAL, Boca Raton, FL (US); Asima SILVA, Holden, MA (US); Jaime M. STOCKTON, Acton, MA (US); Cheranellore VASUDEVAN, Bastrop, TX (US)

(73) Assignee: INTERNATIONAL BUSINESS MACHINES CORPORATION, Armonk, NY (US)

(21) Appl. No.: 15/398,363

(22) Filed: Jan. 4, 2017

(51) Int. Cl. G06Q 10/10; G06N 99/00

(52) U.S. Cl. CPC G06Q 10/1095; G06N 99/005

(57) ABSTRACT

Embodiments for intelligent scheduling management by a processor. One or more time slots are cognitively identified for scheduling a meeting according to a plurality of identified contextual factors, scheduling availability, an attendance confidence level assigned to each of the one or more users, and meeting topic and objective such that a user aggregation contribution score is provided for the one or more time slots. A meeting is scheduled during the one or more time slots for one or more users according to the user aggregation contribution score.

### BACKGROUND OF THE INVENTION

### Field of the Invention

The present invention relates in general to computing systems, and more particularly to, various embodiments for intelligent scheduling management by a processor.

### Description of the Related Art

In today's society, consumers, businesspersons, educators, and others communicate over a wide variety of mediums in real time, across great distances, and many times without boundaries or borders. The advent of computers and networking technologies have made possible the intercommunication of people from one side of the world to the other. The increasing complexity of society, coupled with the evolution of technology continue to engender the sharing of a vast amount of information between people. For example, many consumers, businesspersons, educators, and others requires extensive use of technology for conducting or hosting meetings for a variety of reasons.

### SUMMARY OF THE INVENTION

Various embodiments for intelligent scheduling management by a processor, are provided. In one embodiment, by way of example only, a method for intelligent scheduling management, again by a processor, is provided. One or more time slots may be cognitively identified for scheduling a meeting according to a plurality of identified contextual factors, scheduling availability, an attendance confidence level assigned to each of the one or more users, and meeting topic and objective such that a user aggregation contribution score is provided for the one or more time slots. A meeting may be scheduled during the one or more time slots for one or more users according to the user aggregation contribution score.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a flowchart diagram depicting an additional exemplary method for intelligent scheduling management by a processor, again in which aspects of the present invention may be realized;

FIG. 5 is an additional block diagram depicting an exemplary functional relationship between various aspects of the present invention;

FIG. 6 is an additional block diagram depicting an exemplary functional relationship using an intelligent scheduler between various aspects of the present invention; and

FIG. 7 is an additional flowchart diagram depicting an additional exemplary method for intelligent scheduling management by a processor, again in which aspects of the present invention may be realized.

### DETAILED DESCRIPTION OF THE DRAWINGS

Organizing an event or meeting can often times be tedious and a daunting task given a variety of factors a meeting scheduler must consider. These factors contribute to a complex and intricate decision making process to accommodate one or more users (e.g., “key attendees”) that may be required to attend the event or meeting. For example, depending on the number of users or “attendees” that may be required or desired to attend the event or meeting, the process of determining a best time slot for scheduling the event or meeting may take several minutes to several weeks, months, or even years to finally identify the best slot. Depending on the priority, topic, and/or objective of each meeting, the agenda, topic, or objective may be changed requiring the event/meeting scheduling process to be repeated causing significant delay or waste of resources.

In short, determining a most efficient time slot for scheduling a meeting with a significant and increased chance of success can be difficult. Key attendees (e.g., required or desired attendees) are expected not only to attend, but participate and effectively contribute to the event or meeting. However, these key attendees may fail to meet the expectations due to not being at their best for the specific activity, event, or meeting for one or more reasons such as for example, having recently attended one or more prior meetings that run over time or have conflicts that arise after a meeting is scheduled.

Thus, the present invention provides a solution to both automatically find a first available time slot, but also identify and locate the best slot (e.g., “optimal” time slot) and/or take into account the context and/or importance of the meeting or persons that are required to attend the event/meeting for achieving a desired effectiveness of a scheduled event, activity, or meeting. More specifically, the defined success or desired effectiveness of a scheduled event, activity, or meeting may depend in large measure on an emotional state or “mood” associated with each attendee. For example, an introductory meeting or telephone call may have a friendly or relaxed emotional state or mood and a quality assurance meeting or telephone call may have a serious emotional state or mood.

Thus, various embodiments of the present invention increase the chance of ensuring the success of determining and scheduling an event, activity, or meeting by ensuring the emotional state or mood of the invitees matches the intended mood of the meeting and factoring in the emotional state or mood of the invitees before, during, and after attendance of the meeting.

In an additional aspect, the present invention provides for intelligent scheduling management. One or more time slots of an electronic calendar may be cognitively identified for scheduling an optimal or “best” time slot for an event, action or meeting according to a plurality of identified contextual factors, scheduling availability, an attendance confidence level assigned to each of the one or more users, and meeting topic and objective such that a user aggregation contribution score is provided for the one or more time slots. A meeting may be scheduled during the one or more time slots for one or more users according to the user aggregation contribution score.

The functionality may also include a cognitive method to optimally schedule a meeting considering not just the availability of the participants, but taking into consideration and evaluation factors such as, for example, 1) one or more user profiles of each participant to understand the attention, behavior, receptivity, and/or emotional state or mood at specific times (e.g., specific days and times) relating to an event, action or meeting, 2) the topic of discussion inferred or directly read including the objectives so that the above factors can be evaluated to best suit the topic, the context and background of the meeting, any related communications of an event, action or meeting, previous meetings on the same topic and the previous meeting outcomes, and/or a combination thereof.

The so-called “optimal time slot” or “best time slot” of an electronic calendar for identifying and scheduling an event, action, or meeting may be very subjective and context dependent. The best time slot may be interpreted and evaluated according to a plurality of identified contextual factors, scheduling availability, an attendance confidence level assigned to each of the one or more users, and meeting topic and objective, and/or the user aggregation contribution score that provides an indication of the likelihood of success participants invited to an event, action, or meeting will effectively contribute therein. Accordingly, the so-called “optimal time slot” or “best time slot” of a particular identified and scheduled event, action, or meeting may depend greatly upon contextual factors, such as a topic-user profile relationship, and other contextual factors. A deeper, cognitive analysis of the identifying and scheduling of an event, action, or meeting is needed, for example based on standards, rules, user profiles, cognitive factors, emotional states, and historical attendance patterns, and the like.

The mechanisms of the illustrated embodiments assist meeting chairs and/or other administrators to schedule events, actions, or meetings that have an increased chance of success by displaying, for different time slots, the participation and attendance confidence level for each key meeting attendee. In addition, the present invention may dynamically update the confidence levels for each attendee as attendees decline and/or accept attendance at other meetings that may impact a scheduled meeting such as, for example, where both meetings may be in direct conflict with one or more time slots.

One or more machine learning models may be invoked and applied to learning over time a level of attendee contribution (e.g., speaking, communicating via electronic devices, interaction with other attendees, etc.) at certain types of events, activities, or meetings and when the attendee contribution occurred such as, for example, the amount of time speaking, engaging in one or more required activities, and/or where other attendees offer positive sentiment in response to the attendee contribution. In one aspect, one or more devices (e.g., microphone, voice capturing endpoint, retina scanner, heart monitor, video camera, and the like) may be used to capture speech, emotional data, biometric data, and/or psychophysical characteristics or parameters (e.g., electro dermal activity, heart rate, blood pressure, etc.) data. Combined with the machine learning, other functionality of the present invention may identify the attendees' preference for times of day, days of weeks, or months/years that may be associated with the attendee peak performance or “confidence score”. The machine learning models may also learn over time what events, activities, or meetings attendees tend to favor over other events, activities, or meetings if there is a conflict and learn/identify the reasons for the user preferences based on subject, attendees, relationship to attendees. The machine learning models may also learn over time what important prior scheduled meetings tend to be favored or have a higher rate of contribution for attendees. The machine learning models may also learn over time what important prior scheduled meetings also result in other meetings being missed or require late attendance to other scheduled events, activities, and/or meetings based on one or more cognitive factors, emotions, user profiles, and/or attendance history. In this way, the success of having enhanced contributions of attendees for scheduled events, activities, and/or meetings is significantly increased while providing increased computing efficiency while saving valued time and other resources.

It should be noted that reference to calculating attendance confidence level and/or user aggregation confidence score may be set as a numerical value, weighted values, and/or an aggregate number of the weighted values that may be compared against the numerical threshold value. In one aspect, calculations may be performed using various mathematical operations or functions that may involve one or more mathematical operations (e.g., using addition, subtraction, division, multiplication, standard deviations, means, averages, percentages, statistical modeling using statistical distributions, by finding minimums, maximums or similar thresholds for combined variables, etc.).

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

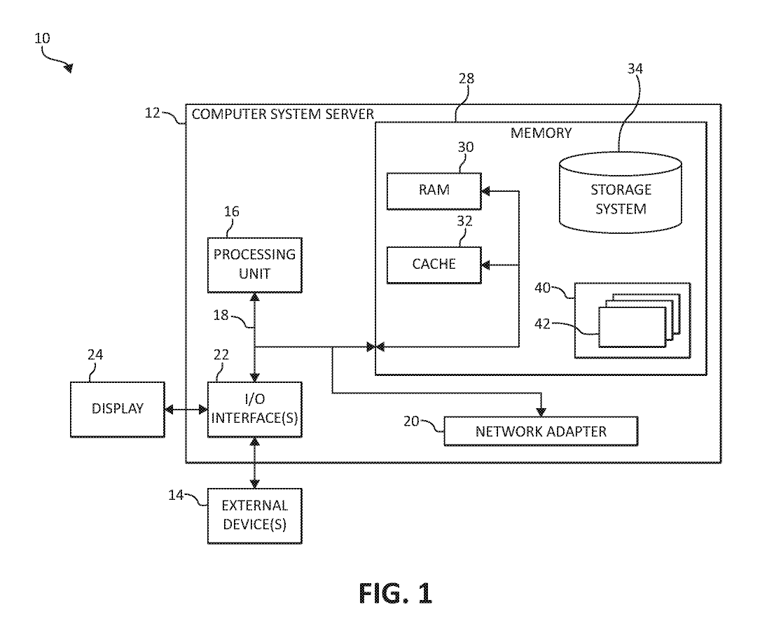

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

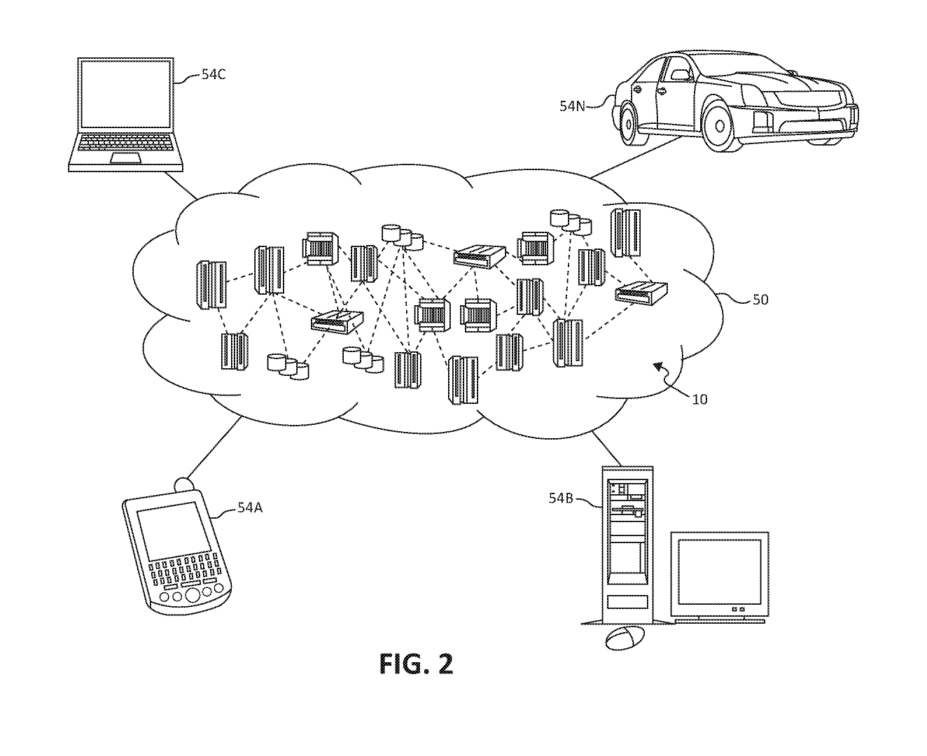

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

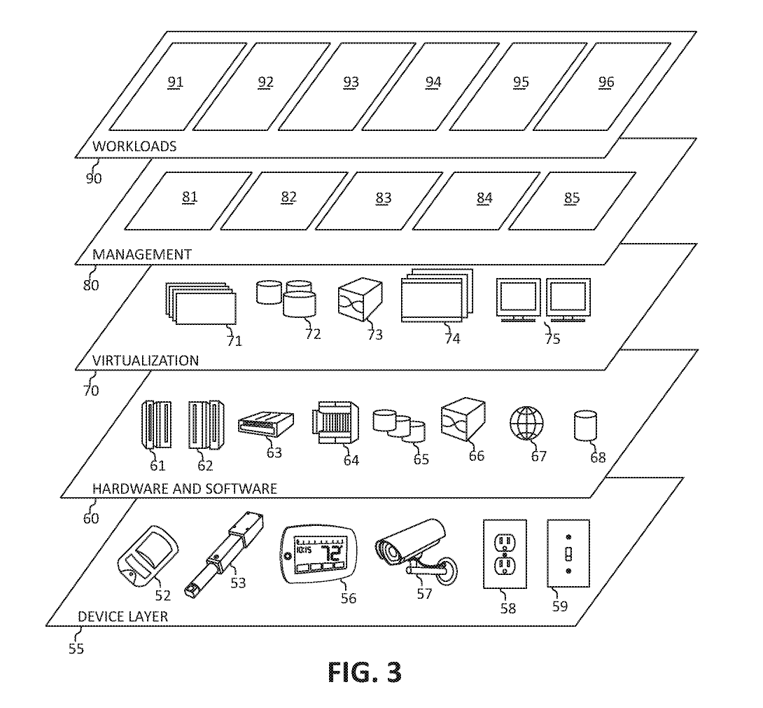

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various intelligent scheduling management workloads and functions 96. In addition, intelligent scheduling management workloads and functions 96 may include such operations as data analytics, data analysis, and as will be further described, notification functionality. One of ordinary skill in the art will appreciate that the intelligent scheduling management workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches to optimally schedule a meeting considering both the availability of the participants and cognitive analysis of a variety of parameters and factors and base the scheduling/rescheduling of the meetings on the cognitive analysis to enable attendees of the meeting to effectively contribute to the objective of the meeting.

These mechanisms may use, in one embodiment, several identified contextual factors, scheduling availability, an attendance confidence level assigned to each of the one or more users, and meeting topic and objective to increase the chance of ensuring the success of determining and scheduling an event, activity, or meeting by ensuring the emotional state or mood of the invitees matches the mood of the meeting and factoring in the emotional state or mood of the invitees before, during, and after attendance of the meeting.

In view of the foregoing, the mechanisms of the illustrated embodiments provide, among other aspects, a cognitive mechanism to analyze and interpret the identified contextual factors, scheduling availability, an attendance confidence level assigned to each of the one or more users, and meeting topic and objective assigned to each of the one or more users, and meeting topic and objective to determine an optimal or best time slot for calendaring or scheduling an event, activity, and/or meeting. As another aspect, the mechanisms provide a representational scheme for context specific rules that identify and schedule the optimal time slot, as well as a methodology to collect potential feedback/reaction relating to the identified and/or scheduled event, activity, and/or meeting.

Further, the mechanisms of the illustrated embodiments implement a machine learning/rule learning system which, based on the particular feedback/reaction, infers new contextual rules or adjusts the user profile, user aggregation contribution score, and/or attendance confidence level, for example. Finally, the mechanisms may implement an intelligent scheduling generator, or auto-scheduling functionality based on the results of the analysis.

By use of the mechanisms of the illustrated embodiments, the confidence level may be dynamically and/or automatically updated for key participant attendance and participation as the attendees accept other meeting invitations that may impact a cognitively scheduled meeting.

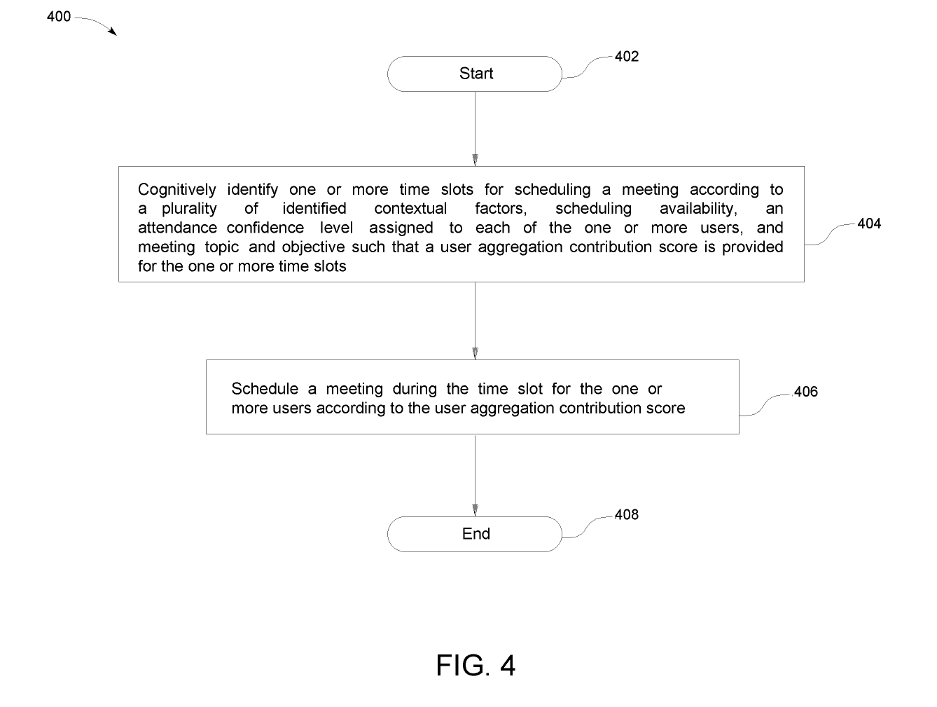

Turning now to FIG. 4, a method 400 for intelligent scheduling management by a processor is depicted. The functionality 400 may be implemented as a method executed as instructions on a machine, where the instructions are included on at least one computer readable medium or one non-transitory machine-readable storage medium. The functionality 400 may start in block 402. One or more time slots (on an electronic calendar) may be cognitively identified for scheduling a meeting according to a plurality of identified contextual factors, scheduling availability, an attendance confidence level assigned to each of the one or more users, and/or meeting topic and objective such that a user aggregation contribution score is provided for the one or more time slots, as in block 404. An event, activity, and/or meeting may be scheduled during the one or more time slots for one or more users according to the user aggregation contribution score, as in block 406. The functionality 400 may end, as in block 408.

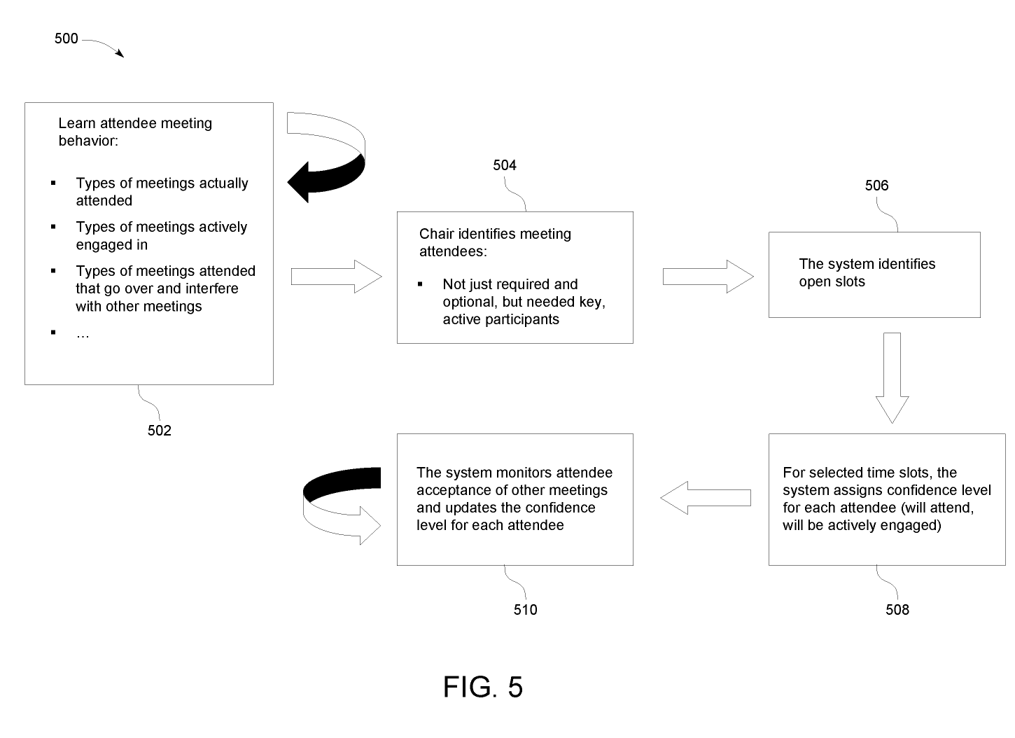

In view of the method 400 of FIG. 4, consider, as an illustration of exemplary functional blocks to accomplish various purposes of the present invention, FIG. 5, following. FIG. 5 illustrates these exemplary functional blocks 500. Each of the functional blocks 500 may be implemented in hardware and/or software, such as by the computer/server 12 (FIG. 1), and/or the workloads layer 90 (FIG. 3).

In the depicted embodiment, a machine learning module as illustrated in block 502 may be used to learn and/or train a machine learning model information relating to a user such as, for example, an attendee of a meeting. More specifically, the machine learning module 502 may learn the attendee's behavior and/or emotional state, types of meeting the user actually attended, the types of meetings in which the user actively participated in or engaged in (e.g., behavioral interaction, speech, behavioral interaction with other attendees, and the like), types of meetings attended that exceed a defined start and stop time, and/or types of meetings that conflict or interfere with other types of meetings. In an identification module, as depicted in block 504, one or more meeting attendees may be identified based on a level of required attendance such as, for example, required attendees, optional attendees, and/or “key, active participants” that are both required and mandatory. One or more time slots may be automatically searched for and/or identified on an electronic calendaring system and provide one or more time slots, as depicted in block 506. At the confidence level module, as depicted in block 508, an attendance confidence level for each user may be assigned for each selected time slot (e.g., assigning the attendance confidence level as a percentage that the user will attend and/or actively engage). Attendee acceptance, rejection, alternative time slot proposal, and/or interaction relating to a scheduled event, activity, and/or meeting may be automatically monitored and cognitively analyzed (shown by box 510).

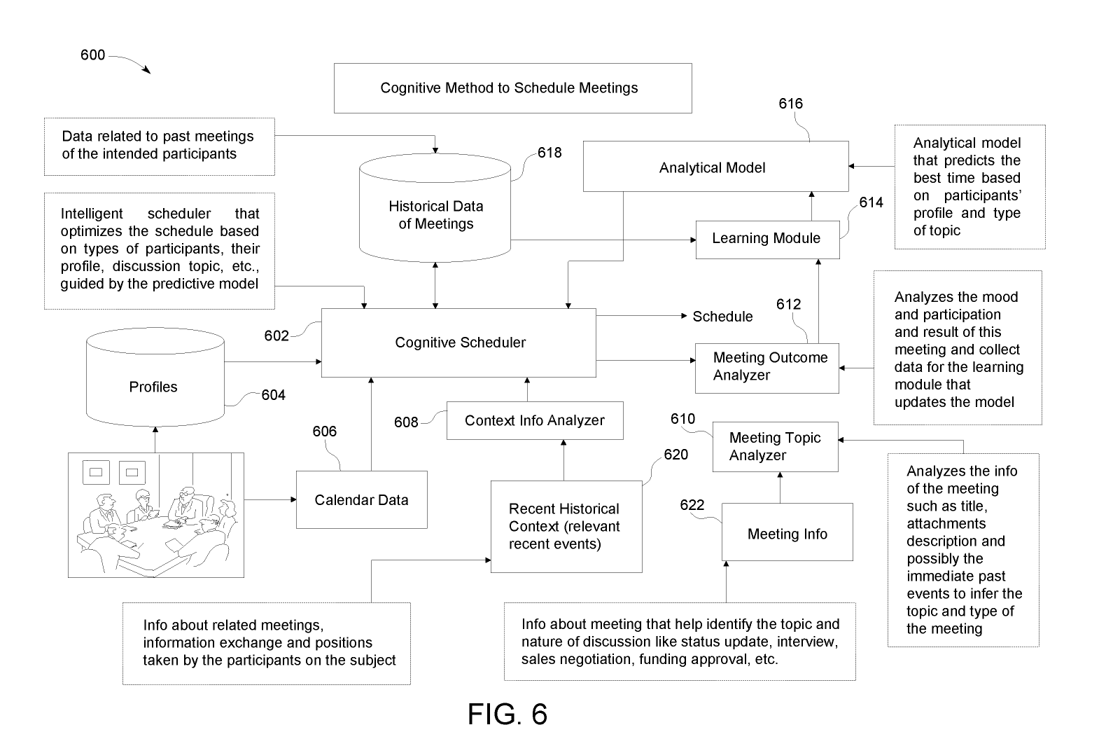

In view of the method 400 of FIG. 4 and block diagram 500 of FIG. 5, consider, as an illustration of exemplary functional blocks to accomplish various purposes of the present invention, FIG. 6, following. FIG. 6 illustrates these exemplary functional blocks 600 and associated notes on specific functionality (as denoted by the doted boxes). Each of the functional blocks 600 may be implemented in hardware and/or software, such as by the computer/server 12 (FIG. 1), and/or the workloads layer 90 (FIG. 3).

An “Intelligent Scheduler” 602 (e.g., “cognitive scheduler) may receive one or more different inputs (e.g., six different inputs). The Intelligent Scheduler 602 may include or be associated with one or more profiles 604 of participants, calendar data 606, context information (info) analyzer 608, meeting topic analyzer 610, meeting outcome analyzer 612, a learning module 614, an analytical model 616, and/or historical data 618. The cognitive scheduler 602 may be a central or “core” engine of an intelligent scheduler that may corroborate all the information that it receives from all the various analysis engines and propose schedules for the meetings.

The calendar data 606 may be calendar data associated with an electronic calendar or related calendaring application.

The one or more profiles 604 of participants may include and/or have access to calendar data 606 that may include the availability information from calendars. In one aspect, the user profile module 604 may include user profile information, names, location information of users and attended meetings, a role, function, title, or employment status of the user. The user profile information needed for cognitive scheduling may include personal preferences for discussion and/or timing of discussions of different types of topics such as, for example, finance (preferred scheduling during morning hours), administration items (preferred scheduling during mid to later afternoon), interviews (preferred scheduling around noon on each Thursday), application status (preferred scheduling during Friday mornings), current logistics that may influence the time zones, immediate past incidents or meetings, individual specific information (e.g., data that indicates the user recently returned from vacation/starting vacation in few hours, traveling, received an extended assignment, tackling an unrelated tough issue, etc.). The user profile may also include incidents that affect all user profiles such as, for example, a company emergency occurring in a specific location.

The context information analyzer 608 may include topics and contextual information about one or more meetings, information about past meetings of the participants, past meetings on a same or similar topic from the historical database 618 and/or from recent historical context (e.g., relevant recent events which may include information about related meetings, information exchanges, positions of each of the participants relating to a topic or subject, and/or historical emotional state data).

The analytical model 616 may provide and advise what rules to apply and what considerations may be taken into account or consideration based on several historical patterns of meetings learned and generalized and stored. In one aspect, the event, action, and/or meeting scheduling may be based on a highest level of determined attention of one or more participants gathered through historical patterns as well as a user profile given logistics and engagement situations and interpreted in the context of the topic of discussion and the context. The context involves the purpose or objective of the upcoming meeting to be scheduled, the outcome of any previous meetings, the nature of meeting (e.g., funding approval, regular status call, a job interview, a negotiation of contract/purchase, etc.). The cognitive scheduler 602 may use the inputs together with the analytical model 616 to decide a best schedule. The analytical model 616 may be an analytical engine that may apply rules based on the contextual information. The analytical model 616 may apply rules based on the resultant context and propose timing for the best possible outcome. The rules may be based on contextual information and allows the analytical model 616 to predict the best suitable time for an optimal outcome for an event, activity, and/or meeting where one or more users have a greater percentage of contributing to the event, activity, and/or meeting.

The meeting information analyzer 610 or “meeting topic analyzer” may perform sentiment analysis of the text/materials associated with the meeting such as, for example, a description of the topic, agenda, attachments, past events to enable inferring the topic or type of meeting, and the like. The meeting information analyzer 610 may analyze and provide information on the nature of the discussion based on topic, status meeting, triage, kickoff, etc.

The context info analyzer 608 may determine the context of the meeting. That is, the context info analyzer 608 may establish the context and/or background of a meeting by analyzing and determining recent interactions of each of the participants via one or more channels of communication leading towards the meeting (e.g., email, telecommunication data, short message service SMS, video conferences, etc.). The context info analyzer 608 may use the input of the meeting information analyzer 610 to further establish the context. The context info analyzer 608 may corroborate the information from the historical database 618 of the meetings that will take into account the history of this type of meeting amongst the participants and also the possible outcomes (e.g., follow up meetings on an unresolved issue has greater chance of reaching to a resolution). The context info analyzer 608 may include the profile specific information also in the context. That is, a role or title of the user may be included in a profile of a user and may be used to identify the context and/or associated with the context. For example, a user may be a “group discussion leader” in a meeting relating to a patent invention disclosure meeting between inventors, which may be used to identify and/or be associated with the context of a meeting.

The meeting outcome analyzer 612 may be responsible for monitoring the emotional state and mood and participation of the attendees and at the end of the meeting will collect data for a learning module 614 to update the learning module and/or profiles based on the collected results of the meeting. The meeting outcome analyzer 612 may feed the collected data information to both the historical database 618 and the learning module 614. The learning module 614 may have cognitive capability of learning and improving predictions based on contextual information. The learning module 614 may learn from one or more scheduled predictions from one or more event, activity, and/or meeting outcomes and may update the rules in the analytical model 616 and the historical database 618.

Consider now the following example of various rules depicted in pseudocode. These rules may be generated out of analyzing and generalizing historical incidents by the analytical model.

Rule Frame 1:

{ {
(Role: Stake Holder)
(Level: Vice President)
(Topic: Weekly Status Reporting)
(Objective: Update / Clarify / Report / Share)
(Action: Comments / corrective suggestions)
}
{
(Preferred Days : Thursday or Friday)
(Preferred Time : Morning to Noon)
}
}

Rule Frame 2:

{ {
(Role: Decision Maker)
(Level: Vice President)
(Topic: Budget Approval)
(Objective: Suggest / Propose)
(Action: Approve / Reject / Amend)
}
{
(Preferred Days : Tuesday, Wednesday, or Thursday)
(Preferred Time : Morning)
}

Rule Frame 3:

{ {
(Role: Technical Evaluator)
(Level: Lead Developer)
(Topic: Design Review)
(Objective: Evaluate Product Design)
(Action: Analyze / Modify / Approve)
}
{
(Preferred Days : Monday, Tuesday, or Wednesday)
(Preferred Time : Afternoon)
}

Consider the following example/use cases of an implementation of the aforementioned functionality. Assume that a company's legal department decides to discuss a potential patent application. Assume that the legal department will only evaluate the idea. When the responsible person from the legal department attempts to schedule the review of the idea, one or more of the following things may occur using the embodiments of the cognitive scheduler, as described herein. First, the Cognitive scheduler (COS) may analyze one or more user profiles of each person that will be attending the meeting.

Assume now, that one or more inventors are from an alternative country. The COS may take into account each of the time differences between each of the various countries. A time slot that relates to an afternoon of the host country may be identified and selected as an optimal time slot so as to accommodate each attendee without disrupting any parties after hour work plans or sleep patterns.

If historical data that has been analyzed indicates that a historical pattern (e.g., a track record) of the legal department scheduling and performing the review calls a majority of the time on a Tuesday, the COS may attempt to identify and schedule the review call on an afternoon of a Tuesday.

If the COS analyzes and identifies that at least 3 members of the legal department are just returning from a summer vacation, the COS will schedule or reschedule the review call for an afternoon on Tuesday that will allow the members of the legal department to catch up and return to a normal operating pattern with their work and also to allow time for reviewing the idea before the actual, scheduled review.

In one aspect, if there has been a determination or decision that a backlog of proposed patent applications for the members of the legal department needs to be cleared before any new cases are considered, the COS will consider this decision or “rule” and may propose another time slot at a later date (e.g., the COS may identify a last most scheduled patent application review and schedule the review call after this identified, last most scheduled patent application review). The COS may also consider the user profiles of the attendees (e.g., each inventor) who will defend their invention/ideas. The COS may also use the meeting information analyzer to perform a semantic analysis in order to know that the review call is about defending patents from the title and links to the patent database. The COS may also identify and determine from the context information analyzer that the last meeting was a decision about a re-submission with more details. When the COS determines information relating to the last meeting in the context of patent board review the COS 602 may give such review meetings priority to enable increased attendee contribution. The analytical model 616 may apply the rules based on one or more user profiles, context and historical data of such meetings and propose a few alternative and appropriate times that could yield a positive outcome according to an assigned attendance confidence level and/or a user aggregation contribution score for each one of the one or more time slots.

The participation, emotional state or mood of each of the attendees and the outcome of the meeting may be analyzed by the meeting outcome analyzer and fed to the learning module which will then analyze if anything can be updated in the analytical model to increase the attendee contribution prediction accuracy of scheduled meetings.

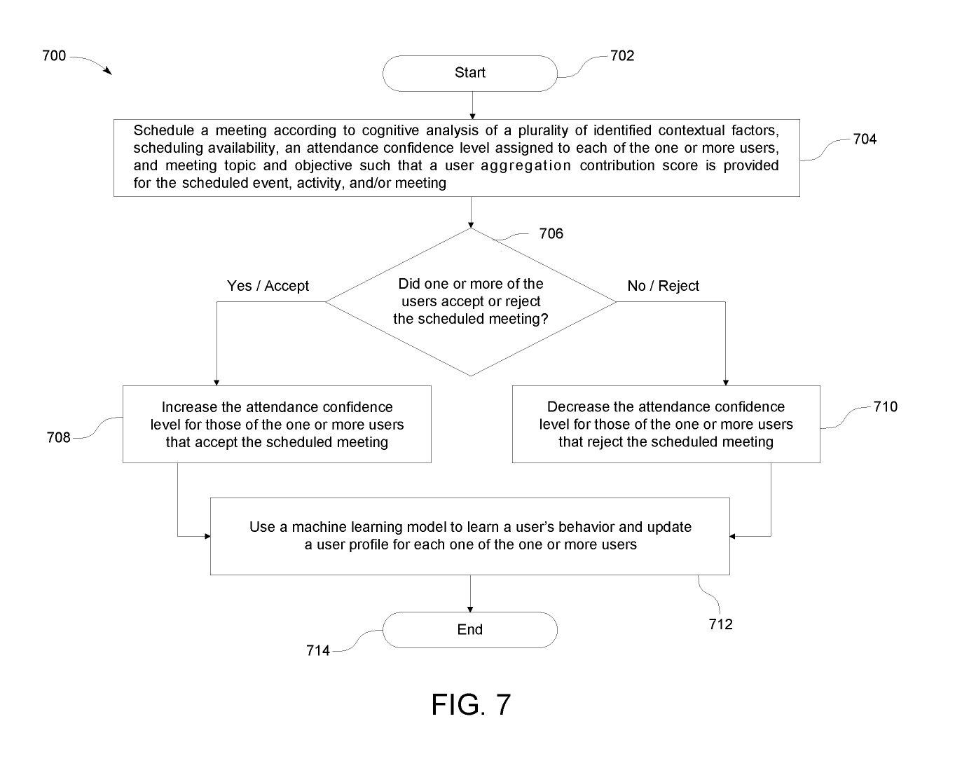

Turning now to FIG. 7, a method 700 for intelligent scheduling management by a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. The functionality 700 may start in block 702. A meeting (or an event or activity) may be scheduled according to cognitive analysis of a plurality of identified contextual factors, scheduling availability, an attendance confidence level assigned to each of the one or more users, and meeting topic and objective such that a user aggregation contribution score is provided for the event, activity, and/or meeting, as in block 704. The user aggregation contribution score may be a score based on an aggregation of each of the data of the plurality of identified contextual factors, the scheduling availability, the attendance confidence level assigned to each of the one or more users, and the meeting topic and objective. A determination is made as to whether the one or more users accepted or rejected the scheduled meeting, as in block 706. The attendance confidence level for those of the one or more users that accept the scheduled meeting may be increased, as in block 708. Alternatively, the attendance confidence level for those of the one or more users that reject the scheduled meeting may be decreased, as in block 710. From both blocks 708 and 710, a machine learning model may be used to learn a user's behavior and update a user's profile, as in block 712. The functionality 700 may end, as in block 714.

In one aspect, in conjunction with and/or as part of at least one block of FIGS. 4, 6, and 7, the operations of methods 400, 600, and/or 700 may include each of the following. The operations of methods 400, 600, and/or 700 may determine the attendance confidence level according to types of meetings attended by the one or more users, an emotional response of a user during a meeting based on the meeting topic and objective (e.g., the emotion response is captured according to a tone or outcome of a meeting based on the topic or object such as, for example, an emotional response of anger, happiness, joy, excitement, approval, disapproval each of which may be captured via a video device, a recording device, biological sensor devices, or other devices for capturing emotion or biological data), a level of engagement or interaction performed by the one or more users during each attended meeting, those of the types of meetings attended that interfere with other meetings, those of the types of meetings attended by the one or more users that have a completion time extending beyond a scheduled time period for completion, an attendance record for each scheduled meeting, or a combination thereof. A machine learning mechanism may be used and employed for learning behavior of the one or more users, an emotional state of each one of the one or more users, a level of interaction and engagement of the one or more users during an attended meeting, a percentage rate for accepting or rescheduling a scheduled meeting, or a combination thereof for a selected time period.

The methods 400, 600, and/or 700 may increase the attendance confidence level for those of the one or more users that accept the scheduled meeting; and/or decrease the attendance confidence level for those of the one or more users that reject the scheduled meeting.

The methods 400, 600, and/or 700 may identify as the identified contextual factors a user profile, data relating to a calendar of each one of the one or more users, information relating to the scheduled meeting, topics of discussion of previously attended meetings, one or more previous meetings on a similar topic relating to the meeting topic and objective, a plurality of communication or documentation relating previously attended meetings by the one or more users, use an analyzer device (e.g., a processor device or a module controlled by a processor device) to cognitively identify the one or more time slots for scheduling the meeting; collect and update data relating to the identified contextual factors upon completion of previously attended meeting to update a user profile of the one or more users, and/or apply one or more rules for using the identified contextual factors based on learned historical patterns. The analyzer device may the analytical model 616 of FIG. 6.

The methods 400, 600, and/or 700 may select a time slot for scheduling the meeting having a highest ranked user aggregation contribution score as compared with other time slots having a lower ranked user aggregation contribution score for the one or more users.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for intelligent scheduling management by a processor, comprising:
cognitively identifying one or more time slots for scheduling a meeting according to a plurality of identified contextual factors, scheduling availability, an attendance confidence level assigned to each of the one or more users, and meeting topic and objective such that a user aggregation contribution score is provided for the one or more time slots; and
scheduling a meeting during the time slot for the one or more users according to the user aggregation contribution score.

2. The method of claim 1, further including determining the attendance confidence level according to types of meetings attended by the one or more users, a level of engagement or interaction performed by the one or more users during each attended meeting, those of the types of meetings attended that interfere with other meetings, those of the types of meetings attended by the one or more users that have a completion time extending beyond a scheduled time period for completion, an attendance record for each scheduled meeting, or a combination thereof, wherein the user aggregation contribution score is a score based on an aggregation of the plurality of identified contextual factors, the scheduling availability, the attendance confidence level assigned to each of the one or more users, and the meeting topic and objective.

3. The method of claim 1, further including initializing a machine learning mechanism for learning behavior of the one or more users, an emotional state of each one of the one or more users, a level of interaction and engagement of the one or more users during an attended meeting, a percentage rate for accepting or rescheduling a scheduled meeting, or a combination thereof for a selected time period.

4. The method of claim 1, further including:
increasing the attendance confidence level for those of the one or more users that accept the scheduled meeting; and
decreasing the attendance confidence level for those of the one or more users that reject the scheduled meeting.

5. The method of claim 1, further including identifying as the identified contextual factors a user profile, an emotional response of a user during a meeting based on the meeting topic and objective, data relating to a calendar of each one of the one or more users, information relating to the scheduled meeting, topics of discussion of previously attended meetings, one or more previous meetings on a similar topic relating to the meeting topic and objective, and a plurality of communication or documentation relating to previously attended meetings by the one or more users.

6. The method of claim 1, further including:
using an analyzer device to cognitively identify the one or more time slots for scheduling the meeting;
collecting and updating data relating to the identified contextual factors upon completion of previously attended meetings to update a user profile of the one or more users; or
applying one or more rules for using the identified contextual factors based on learned historical patterns.

7. The method of claim 1, further including selecting a time slot for scheduling the meeting having a highest ranked user aggregation contribution score as compared with other time slots having a lower ranked user aggregation contribution score for the one or more users.

8. A system for intelligent scheduling management, comprising:
one or more processors, operational within and between a distributed computing environment, that:
cognitively identify one or more time slots for scheduling a meeting according to a plurality of identified contextual factors, scheduling availability, an attendance confidence level assigned to each of the one or more users, and meeting topic and objective such that a user aggregation contribution score is provided for the one or more time slots; and
schedule a meeting for one or more users according to the user aggregation contribution score.

9. The system of claim 8, wherein the one or more processors determine the attendance confidence level according to types of meetings attended by the one or more users, a level of engagement or interaction performed by the one or more users during each attended meeting, those of the types of meetings attended that interfere with other meetings, those of the types of meetings attended by the one or more users that have a completion time extending beyond a scheduled time period for completion, an attendance record for each scheduled meeting, or a combination thereof, wherein the user aggregation contribution score is a score based on an aggregation of the plurality of identified contextual factors, the scheduling availability, the attendance confidence level assigned to each of the one or more users, and the meeting topic and objective.

10. The system of claim 8, wherein the one or more processors initialize a machine learning mechanism for learning behavior of the one or more users, an emotional state of each one of the one or more users, a level of interaction and engagement of the one or more users during an attended meeting, a percentage rate for accepting or rescheduling a scheduled meeting, or a combination thereof for a selected time period.

11. The system of claim 8, wherein the one or more processors:
increase the attendance confidence level for those of the one or more users that accept the scheduled meeting; and
decrease the attendance confidence level for those of the one or more users that reject the scheduled meeting.

12. The system of claim 8, wherein the one or more processors identify as the identified contextual factors a user profile, an emotional response of a user during a meeting based on the meeting topic and objective, data relating to a calendar of each one of the one or more users, information relating to the scheduled meeting, topics of discussion of previously attended meetings, one or more previous meetings on a similar topic relating to the meeting topic and objective, and a plurality of communication or documentation relating to previously attended meetings by the one or more users.

13. The system of claim 8, wherein the one or more processors:
use an analyzer device to cognitively identify the one or more time slots for scheduling the meeting;
collect and update data relating to the identified contextual factors upon completion of previously attended meetings to update a user profile of the one or more users; or apply one or more rules for using the identified contextual factors based on learned historical patterns.

14. The system of claim 8, wherein the one or more processors select a time slot for scheduling the meeting having a highest ranked user aggregation contribution score as compared with other time slots having a lower ranked user aggregation contribution score for the one or more users.

15. A computer program product for intelligent scheduling management by a processor, the computer program product comprising a non-transitory computer-readable storage medium having computer-readable program code portions stored therein, the computer-readable program code portions comprising:
an executable portion that cognitively identifies one or more time slots for scheduling a meeting according to a plurality of identified contextual factors, scheduling availability, an attendance confidence level assigned to each of the one or more users, and meeting topic and objective such that a user aggregation contribution score is provided for the one or more time slots; and
an executable portion that schedules a meeting for one or more users according to the user aggregation contribution score.

16. The computer program product of claim 15, further including an executable portion that determines the attendance confidence level according to types of meetings attended by the one or more users, an emotional response of a user during a meeting based on the meeting topic and objective, a level of engagement or interaction performed by the one or more users during each attended meeting, those of the types of meetings attended that interfere with other meetings, those of the types of meetings attended by the one or more users that have a completion time extending beyond a scheduled time period for completion, an attendance record for each scheduled meeting, or a combination thereof, wherein the user aggregation contribution score is a score based on an aggregation of the plurality of identified contextual factors, the scheduling availability, the attendance confidence level assigned to each of the one or more users, and the meeting topic and objective.

17. The computer program product of claim 15, further including an executable portion that initializes a machine learning mechanism for learning behavior of the one or more users, an emotional state of each one of the one or more users, a level of interaction and engagement of the one or more users during an attended meeting, a percentage rate for accepting or rescheduling a scheduled meeting, or a combination thereof for a selected time period.

18. The computer program product of claim 15, further including an executable portion that:
increases the attendance confidence level for those of the one or more users that accept the scheduled meeting;
decreases the attendance confidence level for those of the one or more users that reject the scheduled meeting; or
identifies as the identified contextual factors a user profile, data relating to a calendar of each one of the one or more users, information relating to the scheduled meeting, topics of discussion of previously attended meetings, one or more previous meetings on a similar topic relating to the meeting topic and objective, and a plurality of communication or documentation relating to previously attended meetings by the one or more users.

19. The computer program product of claim 15, further including an executable portion that:
uses an analyzer device to cognitively identify the one or more time slots for scheduling the meeting;
collects and updates data relating to the identified contextual factors upon completion of previously attended meeting to update a user profile of the one or more users; or
applies one or more rules for using the identified contextual factors based on learned historical patterns.

20. The computer program product of claim 15, further including an executable portion that selects a time slot for scheduling the meeting having a highest ranked user aggregation contribution score as compared with other time slots having a lower ranked user aggregation contribution score for the one or more users.
